(19) United States
(12) Patent Application Publication
(10) Pub. No.: US 2020/0302147 A1
(43) Pub. Date: Sep. 24, 2020

(54) BIOMETRIC INPUT DEVICE

(71) Applicant: AMAZON TECHNOLOGIES, INC., Seattle, WA (US)

(72) Inventors: HUNTER GABRIELE, SEATTLE, WA (US); HYUNGUE PARK, ISSAQUAH, WA (US); MATTHEW CHRISTOPHER SMITH, SEATTLE, WA (US); MARKUS STEFAN DUELLI, SEATTLE, WA (US); HOWIE HO WAI LAU, SEATTLE, WA (US)

(21) Appl. No.: 16/359,469

(22) Filed: Mar. 20, 2019

(51) Int. Cl. G06K 9/00; G06K 9/20; H04N 5/33; G06K 7/00; G02B 5/30; G03B 15/05

(52) U.S. Cl. CPC G06K 9/00033; G06K 9/209; H04N 5/33; G03B 2215/0592; G02B 5/3058; G03B 15/05; G03B 2215/0575; G06K 7/0021

(57) ABSTRACT

A biometric input device includes a sensor assembly that generates images of a user's palm that is within a field of view (FOV) using an image sensor behind a polarizer with a first polarization. The palm within the FOV is illuminated at different times with light having the first polarization and the second polarization. The images are acquired using polarized light and provide images of surface and subcutaneous features. The images may then be processed to identify the user. The device may include a touchscreen to provide information to the user or receive input from a user. The device may include a stand to mount the device at a convenient location, such as at an entry portal, point of sale, and so forth.

### BACKGROUND

Facilities such as stores, libraries, hospitals, offices, apartments, and so forth, may need the ability to identify users at the facility.

### BRIEF DESCRIPTION OF FIGURES

The detailed description is set forth with reference to the accompanying figures. In the figures, the left-most digit(s) of a reference number identifies the figure in which the reference number first appears. The use of the same reference numbers in different figures indicates similar or identical items or features. The figures are not necessarily drawn to scale, and in some figures, the proportions or other aspects may be exaggerated to facilitate comprehension of particular aspects.

FIG. 1 illustrates a biometric input device, according to some implementations.

FIG. 2 illustrates a side view of the device with the interior components including a sensor assembly and a mainboard assembly, according to some implementations.

FIG. 3 illustrates a cutaway view of the sensor assembly of the device, according to some implementations.

FIG. 4 illustrates a perspective view of the sensor assembly of the device, according to some implementations.

FIG. 5 illustrates an exploded view of the sensor assembly of the device, according to some implementations.

FIG. 6 illustrates a plan view of a portion of the sensor assembly of the device, according to some implementations.

FIG. 7 illustrates a view of a camera assembly of the device, according to some implementations.

FIG. 8 is a block diagram of the device, according to some implementations.

While implementations are described herein by way of example, those skilled in the art will recognize that the implementations are not limited to the examples or figures described. It should be understood that the figures and detailed description thereto are not intended to limit implementations to the particular form disclosed but, on the contrary, the intention is to cover all modifications, equivalents, and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to.

### DETAILED DESCRIPTION

Accurate and fast identification of a user provides information that may be used in a variety of ways including access, payment, and so forth. In one situation, biometric input may be used to control physical access to a facility or portion thereof. For example, entrance to an office, residence, warehouse, transportation facility, or other location, may be responsive to a user presenting biometric input at an entry portal. If the biometric input corresponds to previously stored data, the user may be permitted to enter.

In another situation biometric input may be used to facilitate payment for goods or services. For example, a user may provide biometric input at a point-of-sale (POS). The biometric input may be used to determine an identity of the user. The identity of the user may then be associated with a payment method, such as an account, previously stored bank or credit card account, and so forth.

In another situation biometric input may be used to sign an electronic record. For example, the biometric input may be used to provide information as to the particular user who agreed to a contract, accepted a delivery, and so forth.

Traditional systems for identifying users suffer from several significant drawbacks including susceptibility to fraud, speed, accuracy, and operational limitations. For example, a traditional system to identify a user by presenting a token, such as an identification card, may be compromised by someone other than an authorized user possessing the token. As a result, systems that involve only the use of “something you have” are vulnerable to misuse. Biometric identification systems deal with this by using a characteristic of the particular individual that is difficult or impossible to copy or be transferred. Operation of traditional biometric identification systems introduce operational problems such as slow data acquisition, limited resolution, increased wear in heavy-use environments, and so forth. For example, traditional palm-based biometric identification systems require physical contact between the user's hand and a scanning device. This physical contact may be deemed unsanitary and may be difficult to accomplish for some users. The data acquired by these systems may also be of relatively low resolution resulting in decreased confidence in the identification. These and other factors result in existing systems being unsuitable for use in situations where rapid identification of users is called for without significantly impeding the flow of user traffic. For example, the delays introduced by existing systems would produce serious negative impacts such as delays in a busy checkout line or at an entry to the facility at rush hours.

Described in this disclosure is a biometric input device (device) that acquires images that may be used for non-contact biometric identification of users. The device includes a sensor assembly that may include a proximity sensor, such as an optical time-of-flight sensor. When the proximity sensor detects a presence of an object, polarized infrared light sources in the device may be activated at different times to provide illumination while a camera in the device that is sensitive to infrared light acquires images at the different times. The images are of objects within the camera's field of view (FOV) and as illuminated by infrared light with different polarizations at different times. For example, a first set of one or more images may be obtained that use infrared light with a first polarization and a second set of one or more images that use infrared light with a second polarization. The camera may include a polarizer with the first polarization. The first set of images depict external characteristics, such as lines and creases in the user's palm while the second set of images depict internal anatomical structures, such as veins, bones, soft tissue, or other structures beneath the epidermis of the skin.

The images, or information based on those images, may then be sent to an external device. For example, the images or information indicative of features in the images may be encrypted and transmitted to a server for processing to determine identity, payment account information, authorization to pass through a portal, and so forth.

The device may include output devices. In one implementation the device may include one or more visible light sources. A light emitting diode (LED) that emits visible light may be operated to provide a visual indication to the user that data acquisition was successful or unsuccessful, to provide positioning prompts, and so forth. A light pipe in the shape of a ring may be arranged around the camera, and direct light from the LED to an exterior of the device. For example, as the user moves their hand into the FOV, the visible light LED may be illuminated blue, illuminating the ring and providing a visible indicator to the user that their hand is within the FOV. In another example, after successful image acquisition, the visible light LED may be illuminated green, illuminating the ring to provide a visible indicator to the user that usable images of their hand have been acquired.

The device may include other output devices, such as a display, speaker, printer, and so forth. For example, a display screen may be used to provide information to the user such as prompting positioning of the hand, indicating acquisition of images was successful, approval or denial of a transaction, and so forth.

The device may include other input devices, such as a card reader, touch sensor, button, microphone, and so forth. The card reader may comprise an EMV card reader that provides wired or wireless communication with an EMV card. For example, the user may insert an EMV card which, along with the images obtained by the sensor assembly, is used to authorize a transaction. The touch sensor may be combined with the display screen to provide a touchscreen. The user may provide input by touching the touchscreen.

The device is compact, allowing easy integration with existing or new systems. The device facilitates rapid and non-contact acquisition of biometric input in a variety of situations. The device is easily deployed and different implementations may be used as a portable device, placed on a supporting structure, affixed to a stand, integrated with another device, and so forth. By using the biometric input produced by the device, a computer system is able to determine the physical presence of a particular user at the particular device at a particular time. This information may be used to authorize payment of a transaction, gain entry to a secured area, sign a contract, and so forth.

### Illustrative System

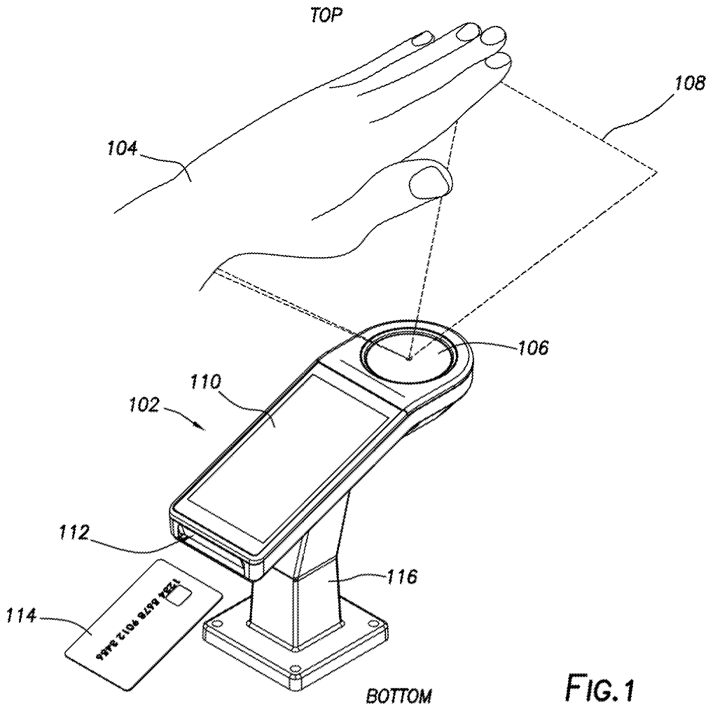

FIG. 1 illustrates a biometric input device 102 (device), according to some implementations. A user may approach the device 102 and place their hand 104 over a sensor window 106 of the device 102. A sensor assembly underneath the sensor window 106 may include a camera with a field of view (FOV) 108. During operation, the camera acquires biometric input, such as one or more images of the hand 104 that is within the FOV 108. The sensor assembly is discussed in more detail below. In this implementation the FOV 108 is oriented generally upwards. In other implementations the FOV 108 may be directed in other directions. For example, the FOV 108 may be directed downward and the user may place their hand 104 beneath the sensor window 106.

The device 102 may include a display device 110 (display). For example, the display 110 may comprise a liquid crystal display that is able to present text, images, and so forth. In some implementations the display 110 may incorporate a touch sensor to operate as a touchscreen.

The device 102 may include a card reader 112 that is able to operate in conjunction with a card 114. The card 114 may comprise a magnetic memory medium such as a magnetic stripe, a microprocessor, or other devices. The card reader 112 may be configured to interact with the card 114 via a wired or physical contact or wirelessly. For example, the card reader 112 may include a magnetic read head, electrical contacts, a near field communication (NFC) communication interface, and so forth. For example, to provide wired connectivity, the card reader 112 may include a plurality of electrical contacts to provide electrical connections to an inserted card 114. In another example, to provide wireless connectivity the card reader 112 may be compliant with at least a portion of the ISO/IEC 14443 specification as promulgated by the International Organization for Standardization (ISO) and the International Electrotechnical Commission (IEC, EMVCo, and so forth). In other implementations the card reader 112 may not be used during operation or may be omitted from the device 102.

A stand 116 may be used to support the device 102. In some implementations the stand 116 may be affixed to a surface. For example, the stand 116 may be attached to a countertop.

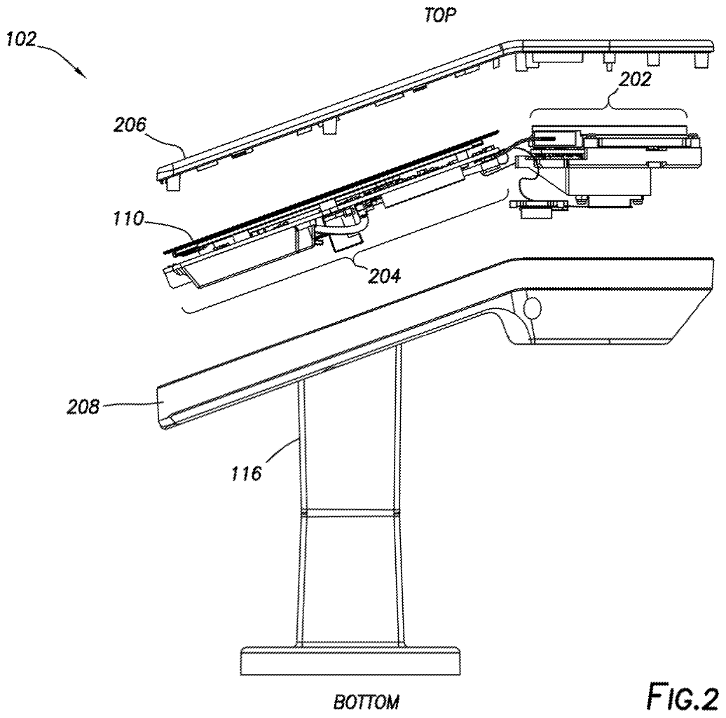

FIG. 2 illustrates a side view of the device 102, according to some implementations. The internal components of the device 102 include a sensor assembly 202 and a mainboard assembly 204. The sensor assembly 202 may include a camera, illuminators, polarizers, and so forth used to obtain biometric input such as images of the hand 104. The mainboard assembly 204 may include the card reader 112, one or more processors, memory, output devices, controllers, input devices, and so forth.

The device 102 may include an upper housing 206 and a lower housing 208. When assembled, the sensor assembly 202 and the mainboard assembly 204 are at least partially enclosed within the upper housing 206 and the lower housing 208. The upper housing 206 and the lower housing 208 have an interior surface proximate to the components enclosed therein and an exterior surface that is exposed to the ambient environment. The stand 116 is also shown attached to an underside of the lower housing 208.

The device 102, or portions thereof, may include antitamper features. The antitamper features may be used to disable at least a portion of the device 102 if unauthorized entry to the device 102 is attempted. For example, the card reader 112 may be encapsulated within an enclosure with one or more electrical conductors. Breakage of the one or more electrical conductors may be registered as an attempt at tampering. Other techniques may be used to determine physical tampering such as detectors for ionizing radiation to determine if the device is being x-rayed. A determination of potential or actual tampering may result in mitigating actions including, but not limited to memory erasure, self-destruction, and so forth.

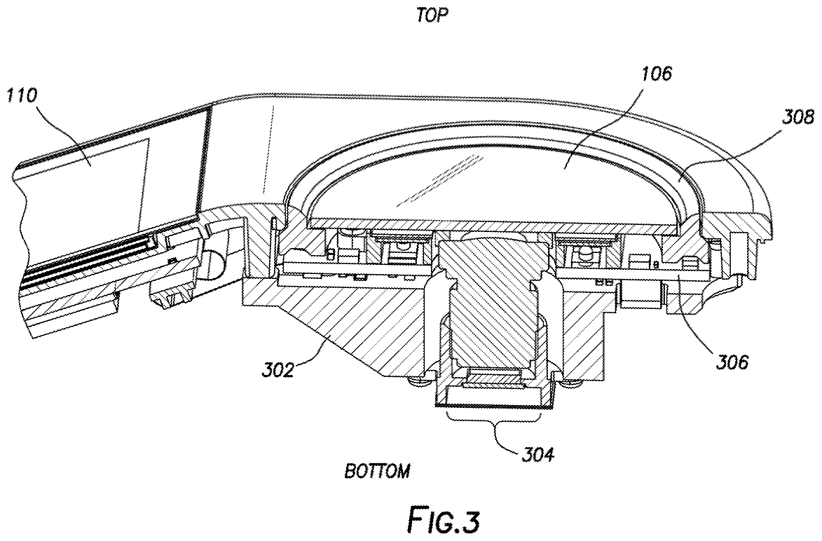

FIG. 3 illustrates a cutaway view of the sensor assembly 202 of the device 102, according to some implementations. A first end of the upper housing 206 includes an opening for the sensor window 106. In this implementation, the opening and the sensor window 106 are circular in shape. The sensor window 106 may be transmissive to infrared light and opaque to visible light. In some implementations the sensor window 106 may include one or more of an antireflective coating, a coating for scratch resistance, an anti-smudge coating, and so forth. The antireflective coating may be present on the exterior (upper) side, the interior (lower) side, or both. The anti-smudge coating may be presented on the exterior (upper) side.

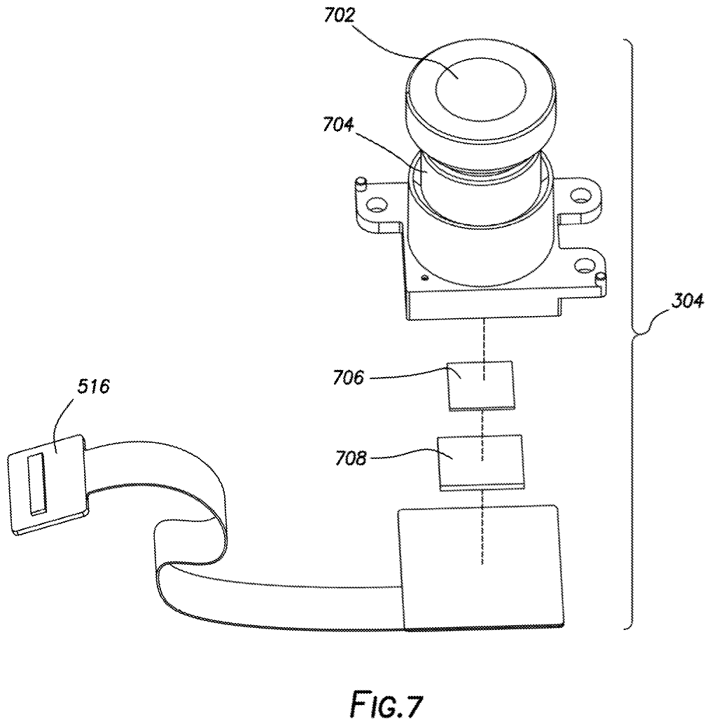

The sensor assembly 202 includes an optical cradle 302, a camera assembly 304, a circuit board 306, and an illumination ring 308. The optical cradle 302 provides a frame or structure that supports the components of the sensor assembly 202. The camera assembly 304 is mounted to the optical cradle 302. The sensor window 106 is arranged between an external environment and the camera assembly 304. The camera assembly 304 includes an image sensor and a polarizer and is described in more detail with regard to FIG. 7.

The circuit board 306 is mounted to an upper surface of the optical cradle 302. The circuit board 306 may include visible light sources, infrared light sources, and so forth. The illumination ring 308 is arranged above the circuit board 306. An interior portion of the illumination ring 308 is thus proximate to a portion of the circuit board 306 and components thereon, such as a visible light LED. An exterior portion of the illumination ring 308 depicted here is generally circular and is arranged within the opening in the upper housing 206.

The illumination ring 308 comprises a light pipe, light guide, optical waveguide, and so forth, directing light produced by the visible light sources on the circuit board 306 such that the light may be visible to the user. For example, the illumination ring 308 may comprise an optically transmissive material, such as transparent or translucent plastic or glass. The illumination ring 308 may be mounted to the optical cradle 302, circuit board 306, upper housing 206, or other portion of the device 102. The sensor window 106 is then affixed to the illumination ring 308. In other implementations the sensor window 106 may have a different shape, such as rectangular, and a light pipe that extends along at least a portion of the perimeter of the sensor window 106 may be used.

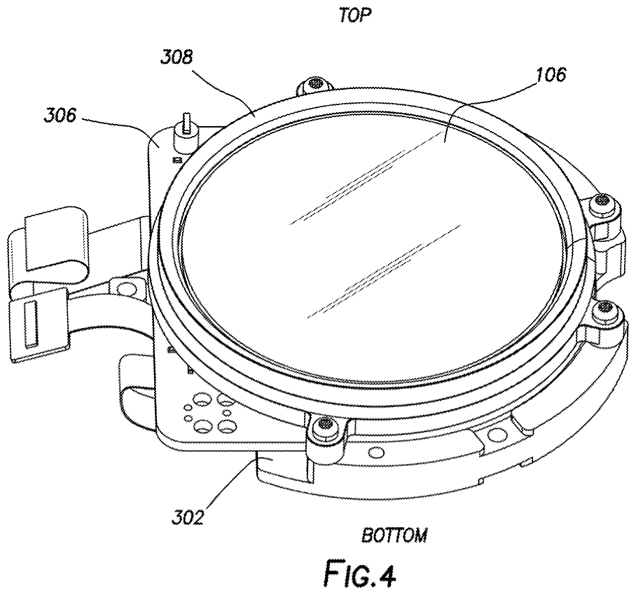

FIG. 4 illustrates a perspective view of the sensor assembly 202 of the device 102, according to some implementations. In this view, the sensor window 106 is in place, mounted to the illumination ring 308. For example, the sensor window 106 may be mounted to the illumination ring 308 using one or more of mechanical fasteners, mechanical retention features, adhesive, and so forth. The illumination ring 308 is mounted to the optical cradle 302 using a plurality of mechanical fasteners. The circuit board 306 is retained between the illumination ring 308 and the optical cradle 302.

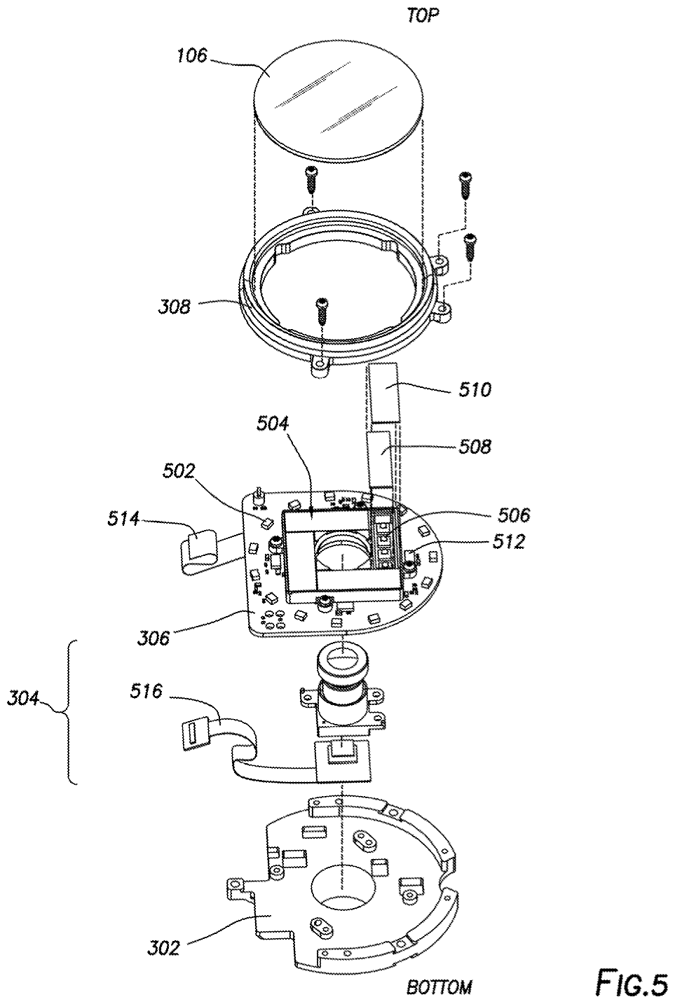

FIG. 5 illustrates an exploded view of the sensor assembly 202 of the device 102, according to some implementations. The sensor window 106 mounted to the illumination ring 308. The circuit board 306 is mounted such that an upper side is proximate to an underside of the illumination ring 308. The circuit board 306 may include one or more visible light sources 502. For example, the visible light sources 502 may comprise light emitting diodes (LEDs), quantum dots, electroluminescent devices, fluorescent devices, lamps, lasers, and so forth. In this illustration, the visible light sources 502 comprise a plurality of LEDs that are placed in a circular configuration along a circular perimeter that corresponds to at least a portion of an interior portion of the illumination ring 308.

The sensor assembly 202 includes one or more polarized infrared light modules (PIRLMs) 504 on the circuit board 306. The PIRLM 504 produces infrared light with a particular polarization. Each PIRLM 504 may include one or more infrared light sources 506. For example, the infrared light sources 506 may comprise LEDs, quantum dots, electroluminescent devices, fluorescent devices, lamps, lasers, and so forth. Continuing the example, the infrared light sources 506 may comprise LEDs that radiate light with a wavelength of between 740 nm and 1000 nm. In one implementation the IR light sources 506 may emit infrared light at 850 nm. In this illustration, each PIRLM 504 includes four infrared LEDs. A polarizer 508 is arranged above the infrared light source 506. A diffuser 510 is arranged above the polarizer 508. The diffuser 510 may comprise a micro lens array (MLA) that diffuses light while maintaining the polarization of light passing through. In other implementations other arrangements may be used. For example, the diffuser 510 may be arranged above the infrared light sources 506 and the polarizer 508 may be arranged above the diffuser 510. In some implementations one or more of the upper or lower surfaces of the diffuser 510 may have an antireflective coating.

The polarizer 508 may comprise a dichroic material or structure that passes light with a linear polarization. For example, the polarizer 508 may comprise aligned polyvinylene chains, silver nanoparticles embedded in a transparent substrate such as glass, and so forth. In other implementations, other polarization devices may be used, including but not limited to wire-grid polarizers, beam-splitting polarizers, quarter-wave plates, liquid crystals, photoelastic modulators, and so forth. For example, the photoelastic modulator may comprise a device that is controlled by an electrical signal which drives a piezoelectric transducer to vibrate a half wave resonant bar, such as fused silica. By changing the frequency of the signal, the frequency of the vibration produced by the transducer is changed, and the polarization of light through the resonant bar may be selected.

In this implementation, four PIRLMs 504 are arranged around the aperture in the circuit board 306. When assembled, the camera assembly 304 may extend at least partially through the aperture. Each PIRLM 504, when activated, emits infrared light with a particular polarization. In some implementations a first pair of PIRLMs 504 may emit infrared light with a first polarization while a second pair of PIRLMs 504 emit infrared light with a second polarization. By selectively operating which pair is illuminated at a particular time, the FOV 108 and objects therein are illuminated by infrared light with a particular polarization.

The sensor assembly 202 may also include one or more proximity sensors 512. For example, a plurality of proximity sensors 512 may be arranged between the PIRLMs 504 and the visible light sources 502. In other implementations the one or more proximity sensors 512 may be arranged with their respective fields-of-view to include at least a portion of the FOV 108. In other implementations the one or more proximity sensor(s) 512 may be placed in other locations. For example, a proximity sensor may be located on the mainboard assembly 204.

The proximity sensor(s) 512 may be used to determine if an object, such as a hand 104, is within the FOV 108. An optical proximity sensor 512 may use time-of-flight (ToF), structured light, optical parallax, interferometry, or other techniques to determine if an object is present and distance data indicative of a distance to at least a portion of the object. For example, an optical parallax proximity sensor 512 may use at least two cameras separated by a known distance to obtain images of the object and determine a position of the object based on the disparity of position of the object in the images. The optical proximity sensor 512 may use infrared light during operation. For example, an infrared optical ToF sensor determines a propagation time (or “round-trip” time) of a pulse of emitted infrared light from an optical emitter or illuminator that is reflected or otherwise returned to an optical detector. By dividing the propagation time in half and multiplying the result by the speed of light in air, the distance to an object may be determined. In another implementation, a structured light pattern may be provided by the optical emitter. A portion of the structured light pattern may then be detected on the object using a sensor such as a camera. Based on an apparent distance between the features of the structured light pattern, the distance to the object may be calculated. Other techniques may also be used to determine distance to the object. In another example, the color of the reflected light may be used to characterize the object, such as skin, clothing, and so forth.

Proximity sensors 512 using other phenomena may also be used instead of or in addition to optical proximity sensors 512. For example, a capacitive sensor may determine proximity of an object based on a change in capacitance at an electrode. In another example, an ultrasonic sensor may use one or more transducers to generate and detect ultrasonic sound. Based on the detection of reflected sounds, information such as presence of an object, distance to the object, and so forth may be determined.

The distance data provided by the proximity sensor(s) 512 may be used to control operation of one or more of the infrared light sources 506 or operation of the camera. In one implementation intensity of output of the infrared light source(s) 506 may be determined at least in part based on the distance. Continuing the example, as the object moves closer to the sensor assembly 202, the intensity of the illumination provided by the infrared light source(s) 506 may decrease, and vice versa. In another implementation the intensity of output of the infrared light source(s) 506 may remain constant while an exposure time for the camera changes. For example, as the object moves closer to the sensor assembly 202, the exposure time used to obtain images may decrease to prevent the resulting images from being overexposed, and vice versa. In yet another implementation the distance data may be used to control both illumination and exposure time.

In some implementations, the intensity of illumination by the infrared light sources 506 may be determined at least in part based on images acquired by the image sensor. For example, if the average intensity of pixels within an acquired image is below a threshold value, the intensity of the infrared light source(s) 506 may be increased. Likewise, if the average intensity of pixels within an acquired image is greater than a threshold value, the intensity of the infrared light source(s) 506 may be decreased. In some implementations the distance data and the image data may be used to control operation of the device or components therein.

In another implementation, the image sensor may be used to determine if there is an object present within the FOV 108. For example, the image sensors may be operated. One or more of the infrared light sources 506 may operate to illuminate the FOV 108. One or more images may be acquired by the image sensor and compared to determine if a change has taken place, either relative to a background image or between successive images. For example, images may be acquired at a rate of 10 images per second. A change that exceeds a threshold would result in an increase in the image acquisition rate and initiate the processed described to acquire images with different polarizations of infrared light.

One or more barriers may also be included in the sensor assembly 202. These barriers may be opaque to infrared light. The barriers may be placed between adjacent PIRLMs 504, between a PIRLM 504 and at least a portion of the camera assembly 304, or at other locations within the device 102. The barriers prevent the light emitted from the IR light source 506 that remains within the device 102 from entering an aperture of the camera assembly 304, such as a lens or pinhole. For example, the barriers prevent infrared light emitted by the infrared light source 506 from “spilling over” and interfering with the light reflected from the hand 104. In one implementation the barriers may comprise a housing for a PIRLM 504. For example, each PIRLM 504 may comprise a unit with a wall that acts as the barrier. In another implementation the barriers may be affixed to, or extend from, the circuit board 306. In yet another implementation the barriers comprise a structure of infrared opaque material that extends from the camera assembly 304 to the sensor window 106. For example, an infrared opaque boot or gasket of flexible material may be arranged between the camera assembly 304 and the interior surface of the sensor window 106. This boot prevents reflections of infrared light that are inside the device 102 from entering the aperture of the camera assembly 304.

A first flexible printed circuit (FPC) 514 extends from the circuit board 306. The first FPC 514 may be used to provide electrical connections to the mainboard assembly 204. A second FPC 516 extends from the camera assembly 304. For example, the first FPC 514 may provide power and control signals to operate the visible light sources 502, the PIRLMs 504, and the proximity sensor 512. The second FPC 516 may be used to provide electrical connections to the mainboard assembly 204. For example, the second FPC 516 may be used to provide control signals to operate an image sensor, operate a variable polarizer, transfer data from the image sensor to the mainboard assembly 204, and so forth.

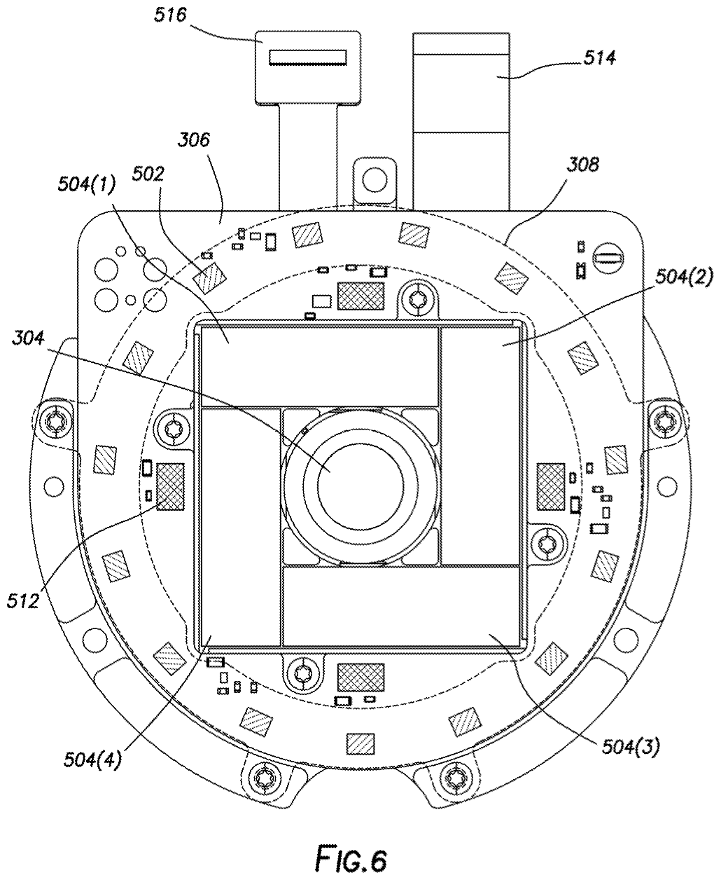

FIG. 6 illustrates a plan view of a portion of the sensor assembly 202 of the device 102, according to some implementations. In this view the first FPC 514 and the second FPC 516 are visible. An outline of the illumination ring 308 is indicated with a dotted line.

An upper portion of the camera assembly 304 is visible in an aperture in the circuit board 306. The camera assembly 304 has an entry for light, such as a lens (as shown here), pinhole, and so forth. Arranged around the entry for light of the camera assembly 304 are four PIRLMs 504(1)-504(4). The PIRLMs 504 may be arranged such that pairs on opposite sides of the camera assembly 304 will emit light with the same polarization. For example, PIRLMs 504(1) and 504(3) may emit infrared light with a first polarization while PIRLMs 504(2) and 504(4) emit infrared light with a second polarization.

Arranged around the PIRLMs 504 are four proximity sensors 512. The proximity sensors 512 are configured to, either individually or in aggregate, be able to detect the presence of an object such as a hand 104 within the FOV 108.

Arranged around a perimeter of the circuit board 306 that encompasses the camera assembly 304 are the visible light sources 502, such as visible light LEDs. In the implementation shown here, the visible light sources 502 are in a circular arrangement. When assembled, a lower portion of the illumination ring 308 is proximate to at least one of the visible light sources 502. When active, at least a portion of the light from the visible light source 502 may be transferred via internal reflection to an exterior portion of the illumination ring 308.

In other implementations other quantities and arrangements of the various components may be used. For example, a different quantity of visible light sources 502, PIRLMs 504, proximity sensors 512, and so forth may be used. While the entry for light of the camera assembly 304 is arranged generally in the center of the sensor assembly 202, in other implementations the camera assembly 304 may be off center, the arrangement of PIRLMs 504 may be asymmetrical, and so forth.

FIG. 7 illustrates a view of the camera assembly 304 of the device 102, according to some implementations. The camera assembly 304 may include a lens 702, lens body 704, polarizer 706, and an image sensor 708. In this illustration, light from the FOV 108 enters the camera assembly 304 through an aperture that includes the lens 702. In other implementations a pinhole may be used to allow for entry of light from the FOV 108. Other lenses or components (not shown) may be present in the optical path that extends from the FOV 108 to the image sensor 708. For example, an optical bandpass filter may be included the optical path. The optical bandpass filter may be configured to pass the wavelength of light generated by the infrared light sources 506. For example, the optical bandpass filter may be transmissive to wavelengths of between 790 nm to 900 nm. In another example, a shutter may be present in the optical path. During operation, the light reaching the image sensor 708 is limited to light with a particular polarization, as restricted by the polarizer 706 in the optical path.

The second FPC 516 connects the image sensor 708 or any associated electronics to the mainboard assembly 204. The second FPC 516 may include one or more traces for transferring power, data, control, and other signals between the electronics in the camera assembly 304 and the mainboard assembly 204. The second FPC 516 may also include one or more antitamper features. For example, the second FPC 516 may include one or more additional layers of an antitamper trace or security mesh. An attempt to physically compromise the second FPC 516 may be detected by breakage of the trace or security mesh.

The polarizer 706 may be fixed or variable. A static polarizer is fixed at time of assembly. The polarizer 706 may comprise a wire-grid polarizer or other structure that passes light with a linear polarization. Materials such as a dichroic material may be used. For example, the polarizer 706 may comprise aligned polyvinylene chains, silver nanoparticles embedded in a transparent substrate such as glass, and so forth. In other implementations, other polarization devices may be used, including but not limited to beam-splitting polarizers, quarter-wave plates, liquid crystals, photoelastic modulators, and so forth.

A variable polarizer 706 allows for control over the polarization selected based on an input. This allows the variable polarizer 706 to change between the first polarization and the second polarization on command from a controller or other electronics. For example, a variable polarizer 706 may comprise a photoelastic modulator that is controlled by an electrical signal which drives a piezoelectric transducer to vibrate a half wave resonant bar, such as fused silica. By changing the frequency of the signal, the frequency of the vibration produced by the transducer is changed, and the polarization of light through the resonant bar may be selected. In another implementation the variable polarizer 706 may comprise a mechanically switchable polarizer that includes two or more different static polarizers that may be selectively inserted into the optical path. For example, one or more actuators such as linear motors, rotary motors, piezoelectric motors, and so forth may be used to move a first static polarizer to be in the optical path, or switch to a second static polarizer in the optical path. The first static polarizer may have the first polarization while the second static polarizer has the second polarization. In yet another implementation, the mechanically switchable polarizer may rotate a static polarizer from a first orientation to a second orientation.

The image sensor 708 is configured to detect infrared light that includes the wavelength(s) emitted by the infrared light sources 506. The image sensor 708 may comprise charge coupled devices (CCD), complementary metal oxide semiconductor (CMOS) devices, microbolometers, and so forth.

The mainboard assembly 204 may include electronics that operate the visible light source(s) 502, operate the infrared light source(s) 506, operate the proximity sensor(s) 512, operate the image sensor 708, and so forth. For example, the proximity sensors 512 may operate to detect the presence of an object, such as a hand 104 in the FOV 108. When the proximity sensor(s) 512 detects a presence of an object, the infrared light sources 506 may be activated at different times to provide illumination with infrared light having a particular polarization, while the image sensor 708 acquires images at the different times.

Distance data obtained by the proximity sensor(s) 512 may be used in the operation of these components. For example, the distance data may be used as an input to control one or more of the intensity of illumination provided by the infrared light source(s) 506 or exposure time of the image sensor 708.

In one implementation intensity of output of the infrared light source(s) 506 may be determined based on the distance data. For example, the intensity of illumination may be proportionate to the distance indicated by the distance data. If the distance to the object is large, the intensity of the illumination is high. Likewise, if the distance to the object is small, the intensity of the illumination is low. In another implementation the exposure time of the image sensor 708 may be proportionate to the distance indicated by the distance data. For example, as the distance to the object decreases, the exposure time used to obtain images may decrease to prevent overexposure of the images. Likewise, if the distance to the object increases the exposure time may increase to prevent underexposure of the images. In another implementation the distance data may be used to control both illumination and exposure time.

The images are of the object within the FOV 108 as illuminated by infrared light with different polarizations at different times. For example, a first set of one or more images may be obtained that use infrared light with a first polarization and a second set of one or more images that use infrared light with a second polarization. When an object such as the hand 104 is illuminated with infrared light having the same polarization as that of the polarizer 706 in the optical path of the image sensor 708, surface features predominate in the resulting image. This is because most of the reflected infrared light has the same polarization due to reflection. In comparison, when the illumination uses a different polarization from the polarizer 706, the scattering from those internal features changes the polarization of the reflected light. As a result, internal anatomical structures, such as veins, bones, soft tissue, or other structures beneath the epidermis of the skin predominate in the resulting image.

The resulting images may be processed and used for biometric identification. The combination of different sets of one or more images that depict predominately surface and predominately deeper anatomical features provide more detail. This increased detail may be used to improve the accuracy of identification, reduce the effect of surface changes impairing identification, and so forth.

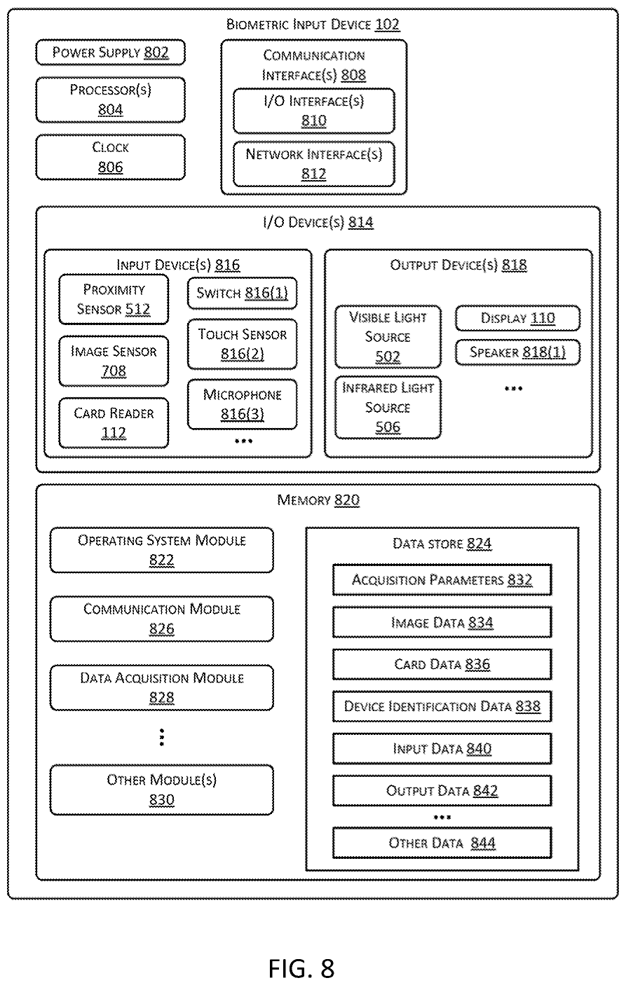

FIG. 8 is a block diagram of the device 102, according to some implementations.

One or more power supplies 802 are configured to provide electrical power suitable for operating the components in the device 102. In some implementations, the power supply 802 may comprise an external power supply that is supplied by line voltage, rechargeable battery, photovoltaic cell, power conditioning circuitry, wireless power receiver, and so forth.

The device 102 may include one or more hardware processors 804 (processors) configured to execute one or more stored instructions. The processors 804 may comprise one or more cores. One or more clocks 806 may provide information indicative of date, time, ticks, and so forth. For example, the processor 804 may use data from the clock 806 to generate a timestamp, trigger a preprogrammed action, and so forth.

The device 102 may include one or more communication interfaces 808 such as input/output (I/O) interfaces 810, network interfaces 812, and so forth. The communication interfaces 808 enable the device 102, or components thereof, to communicate with other devices or components. The communication interfaces 808 may include one or more I/O interfaces 810. The I/O interfaces 810 may comprise interfaces such as Bluetooth, ZigBee, Inter-Integrated Circuit (I2C), Serial Peripheral Interface bus (SPI), Universal Serial Bus (USB) as promulgated by the USB Implementers Forum, RS-232, and so forth.

The network interfaces 812 are configured to provide communications between the device 102 and other devices, such as access points, point-of-sale devices, payment terminals, servers, and so forth. The network interfaces 812 may include devices configured to couple to wired or wireless personal area networks (PANS), local area networks (LANs), wide area networks (WANs), and so forth. For example, the network interfaces 812 may include devices compatible with Ethernet, Wi-Fi, 4G, 5G, LTE, and so forth.

The device 102 may also include one or more busses or other internal communications hardware or software that allow for the transfer of data between the various modules and components of the device 102.

The I/O interface(s) 810 may couple to one or more I/O devices 814. The I/O devices 814 may include input devices 816 and output devices 818.

The input devices 816 may include the proximity sensor(s) 512, the image sensor 708 in the camera assembly 304 and one or more of the card reader 112, a switch 816(1), a touch sensor 816(2), a microphone 816(3), and so forth.

Additional proximity sensors 512 may be employed by the device 102. A proximity sensor 512 may be positioned on the device 102 to detect the presence of an object outside of the FOV 108 as well. For example, a proximity sensor 512 may be arranged to detect a user as they approach the device 102. Responsive to this detection, the device 102 may present information on the display 110, illuminate the visible light sources 502, operate the image sensor 708 and infrared light sources 506, and so forth.

The switch 816(1) is configured to accept input from the user. The switch 816(1) may comprise mechanical, capacitive, optical, or other mechanisms. For example, the switch 816(1) may comprise mechanical switches configured to accept an applied force from a user's finger press to generate an input signal.

The touch sensor 816(2) may use resistive, capacitive, surface capacitance, projected capacitance, mutual capacitance, optical, Interpolating Force-Sensitive Resistance (IFSR), or other mechanisms to determine the position of a touch or near-touch of the user. For example, the IFSR may comprise a material configured to change electrical resistance responsive to an applied force. The location within the material of that change in electrical resistance may indicate the position of the touch.

The microphone 816(3) may be configured to acquire information about sound present in the environment. In some implementations, a plurality of microphones 816(3) may be used to form a microphone array. The microphone array may implement beamforming techniques to provide for directionality of gain. For example, the gain may be directed towards the expected location of the user during operation of the device 102.

Output devices 818 may include one or more of the visible light source(s) 502, the infrared light source 506, the display 110, a speaker 818(1), printer, haptic output device, or other devices. For example, the display 110 may be used to provide information via a graphical user interface to the user. In another example, a printer may be used to print a receipt.

In some embodiments, the I/O devices 814 may be physically incorporated with the device 102 or may be externally placed.

The device 102 may include one or more memories 820. The memory 820 comprises one or more computer-readable storage media (CRSM). The CRSM may be any one or more of an electronic storage medium, a magnetic storage medium, an optical storage medium, a quantum storage medium, a mechanical computer storage medium, and so forth. The memory 820 provides storage of computer-readable instructions, data structures, program modules, and other data for the operation of the device 102. A few example functional modules are shown stored in the memory 820, although the same functionality may alternatively be implemented in hardware, firmware, or as a system on a chip (SOC).

The memory 820 may include at least one operating system (OS) module 822. The OS module 822 is configured to manage hardware resource devices such as the I/O interfaces 810, the network interfaces 812, the I/O devices 814, and provide various services to applications or modules executing on the processors 804. The OS module 822 may implement a variant of the FreeBSD operating system as promulgated by the FreeBSD Project; other UNIX or UNIX-like operating system; a variation of the Linux operating system as promulgated by Linus Torvalds; the Windows operating system from Microsoft Corporation of Redmond, Washington, USA; the Android operating system from Google Corporation of Mountain View, Calif., USA; the iOS operating system from Apple Corporation of Cupertino, Calif., USA; or other operating systems.

A data store 824 that includes one or more of the following modules may be stored in the memory 820. These modules may be executed as foreground applications, background tasks, daemons, and so forth. The modules may include one or more of a communication module 826, data acquisition module 828, or other modules 830. The data store 824 may use a flat file, database, linked list, tree, executable code, script, or other data structure to store information. In some implementations, the data store 824 or a portion of the data store 824 may be distributed across one or more other devices.

A communication module 826 may be configured to establish communications with one or more other devices. The communications may be authenticated, encrypted, and so forth. The communication module 826 may also control the communication interfaces 808.

The data acquisition module 828 is configured to acquire data from the input devices 816. One or more acquisition parameters 832 may be stored in the memory 820. The acquisition parameters 832 may specify operation of the data acquisition module 828, such as data sample rate, sample frequency, scheduling, and so forth. The data acquisition module 828 may be configured to operate the image sensor 708, infrared light source(s) 506, and so forth. For example, the data acquisition module 828 may acquire data from the proximity sensor 512, image sensor 708, or both to determine that an object is in the FOV 108. Based on this determination, at a first time a first set of IR light sources 506 associated with one or more PIRLMs 504 are activated to provide infrared illumination with a first polarization while the image sensor 708 is used to acquire images. At a second time a second set of IR light sources 506 associated with one or more PIRLMs 504 are activated to provide infrared illumination with a second polarization while the image sensor 708 is used to acquire images. Alternatively, at the second time the one or more PIRLMs 504 may be activated to provide infrared illumination with the first polarization while the polarizer 706 in the optical path of the image sensor 708 is set to the second polarization. The images may be stored as image data 834 in the data store 824.

In some implementations, instead of or in addition to data from the proximity sensors 512, data from the image sensor 708 may be used to determine the presence of an object in the FOV 108. For example, the image sensor 708 and one or more of the PIRLMs 504 may be operated at a first sample rate, such as acquiring and illuminating 10 times per second. An acquired image may be processed to determine if changes in the image exceeds a threshold value. For example, a first image may be compared with a second image to determine if there is a change. The change may be deemed to be indicative of an object within the FOV 108. Responsive to the change, the system may operate as described above, acquiring images with different polarizations of infrared light. In other implementations other techniques may be used to initiate acquisition of images with different polarizations of infrared light. For example, if a neural network determines a hand is present in the image, the system may increase the sample rate and operate as described above to acquire images with different polarizations of infrared light.

In some implementations, the IR bandpass filter may be removed from the optical path while acquiring images to determine the presence of an object. For example, a mechanical actuator may be used to move the IR bandpass filter into and out of the optical path. By removing the IR bandpass filter, the ambient light may be sufficient to allow acquisition of an image for object detection in the FOV 108 without the use of the PIRLM 504.

The image data 832 may be sent to another device, processed by the processor 804, and so forth. For example, in one implementation the image data 834 may be processed to determine one or more features present in the image data 834. Data indicative of the features may be encrypted and sent to an external device, such as a server.

The data acquisition module 828 may obtain data from other input devices 816. For example, card data 836 may be obtained from the card reader 112. The card data 836 may comprise encrypted data provided by a processor of the card reader 112.

Device identification data 838 may be stored in the data store 824. The device identification data 838 may provide information that is indicative of the specific device 102. For example, the device identification data 838 may comprise a cryptographically signed digital signature.

The data acquisition module 828 may store input data 840 obtained from other sensors. For example, input from a switch 816(1) or touch sensor 816(2) may be used to generate input data 840.

The other modules 830 may include a feature determination module that generates feature vectors that are representative of features present in the image data 834. The feature determination module may utilize one or more neural networks that accept image data 834 as input and provide one or more feature vectors as output.

The data store 824 may store output data 842. For example, the output data 842 may comprise the feature vectors generated by processing the image data 834.

The other modules 830 may include a user interface module that provides a user interface using one or more of the I/O devices 814. The user interface module may be used to obtain input from the user, present information to the user, and so forth. For example, the user interface module may accept input from the user via the touch sensor 816(2) and use the visible light source(s) 502 to provide output to the user.

Other data 844 may also be stored in the data store 824.

The devices and techniques described in this disclosure may be used in a variety of settings. For example, the system may be used in conjunction with a point-of-sale (POS) device. The user may present their hand 104 to a device 102 that is used to obtain biometric data indicative of intent and authorization to pay with an account associated with their identity. In another example, a robot may incorporate a device 102. The robot may use the device 102 to obtain biometric data that is then used to determine whether to deliver a parcel to the user 102, and based on the identification, which parcel to deliver.

The processes discussed herein may be implemented in hardware, software, or a combination thereof. In the context of software, the described operations represent computer-executable instructions stored on one or more non-transitory computer-readable storage media that, when executed by one or more processors, perform the recited operations. Generally, computer-executable instructions include routines, programs, objects, components, data structures, and the like that perform particular functions or implement particular abstract data types. Those having ordinary skill in the art will readily recognize that certain steps or operations illustrated in the figures above may be eliminated, combined, or performed in an alternate order. Any steps or operations may be performed serially or in parallel. Furthermore, the order in which the operations are described is not intended to be construed as a limitation.

Embodiments may be provided as a software program or computer program product including a non-transitory computer-readable storage medium having stored thereon instructions (in compressed or uncompressed form) that may be used to program a computer (or other electronic device) to perform processes or methods described herein. The computer-readable storage medium may be one or more of an electronic storage medium, a magnetic storage medium, an optical storage medium, a quantum storage medium, and so forth. For example, the computer-readable storage media may include, but is not limited to, hard drives, floppy diskettes, optical disks, read-only memories (ROMs), random access memories (RAMS), erasable programmable ROMs (EPROMs), electrically erasable programmable ROMs (EEPROMs), flash memory, magnetic or optical cards, solid-state memory devices, or other types of physical media suitable for storing electronic instructions. Further, embodiments may also be provided as a computer program product including a transitory machine-readable signal (in compressed or uncompressed form). Examples of transitory machine-readable signals, whether modulated using a carrier or unmodulated, include, but are not limited to, signals that a computer system or machine hosting or running a computer program can be configured to access, including signals transferred by one or more networks. For example, the transitory machine-readable signal may comprise transmission of software by the Internet.

Separate instances of these programs can be executed on or distributed across any number of separate computer systems. Thus, although certain steps have been described as being performed by certain devices, software programs, processes, or entities, this need not be the case, and a variety of alternative implementations will be understood by those having ordinary skill in the art.

Additionally, those having ordinary skill in the art will readily recognize that the techniques described above can be utilized in a variety of devices, environments, and situations. Although the subject matter has been described in language specific to structural features or methodological acts, it is to be understood that the subject matter defined in the appended claims is not necessarily limited to the specific features or acts described. Rather, the specific features and acts are disclosed as illustrative forms of implementing the claims.

What is claimed is:

1. A device comprising:
an upper housing having a first opening;
a lower housing; and
a sensor assembly enclosed by the upper housing and the lower housing, the sensor assembly comprising:
a first circuit board having an upper side and a lower side;
an infrared optical time-of-flight sensor mounted on the upper side of the first circuit board, wherein the infrared optical time-of-flight sensor has a first field of view (FOV) that is directed away from the first circuit board;
a first visible light source mounted on the upper side of the first circuit board;
an illumination ring comprising an optically transmissive material, wherein a first portion of the illumination ring is proximate to the first visible light source and a second portion of the illumination ring is within the first opening of the upper housing; and
a first polarized infrared light module mounted to the upper side of the first circuit board, wherein the first polarized infrared light module comprises:
a first infrared light source,
a first polarizer, with a first polarization, that is mounted above the first infrared light source, and
a first diffuser mounted above the first polarizer;
a second polarized infrared light module mounted to the upper side of the first circuit board, wherein the second polarized infrared light module comprises:
a second infrared light source,
a second polarizer, with a second polarization, that is mounted above the second infrared light source, and
a second diffuser mounted above the second polarizer;
a camera assembly comprising:
one or more lenses,
an image sensor that is sensitive to infrared light, and
a third polarizer, with the first polarization, that is mounted between the one or more lenses and the image sensor;
a sensor window mounted above the upper side of the first circuit board within the first opening of the upper housing, wherein the sensor window is transmissive to infrared light and opaque to visible light; and
electronics, also enclosed by the upper housing and the lower housing, the electronics comprising:
a memory, storing first computer-executable instructions; and
a hardware processor to execute the first computer-executable instructions to:
operate the optical time-of-flight sensor;
operate the first visible light source;
operate the first infrared light source;
operate the second infrared light source; and
operate the image sensor.

2. The device of claim 1, further comprising:
a display device; and
a card reader comprising one or more of:
a plurality of electrical contacts to provide electrical connections to an inserted card, or
a near field communication (NFC) communication interface.

3. A device comprising:
a camera assembly comprising:
an image sensor that is sensitive to infrared light, wherein the image sensor acquires images from within a first field of view (FOV), and
a first polarizer with a first polarization, wherein the first polarizer is in an optical path of the image sensor;
a first polarized infrared light module to illuminate at least a portion of the first FOV, the first polarized infrared light module comprising:
a first infrared light source,
a second polarizer with a second polarization, and
a second polarized infrared light module to illuminate at least a portion of the first FOV, the second polarized infrared light module comprising:
a second infrared light source, and
a third polarizer with the first polarization.

4. The device of claim 3, wherein the first polarizer comprises a wire-grid polarizer.

5. The device of claim 3, wherein the first polarization is linear in a first direction and the second polarization is linear in a second direction that is perpendicular to the first direction.

6. The device of claim 3, the first polarized infrared light module further comprising:
a first barrier that is opaque to infrared light, wherein the first barrier is between the first infrared light source and the camera assembly; and
the second polarized infrared light module further comprising:
a second barrier that is opaque to infrared light, wherein the second barrier is between the second infrared light source and the camera assembly.

7. The device of claim 3, the first polarized infrared light module further comprising a first diffuser; and
the second polarized infrared light module further comprising a second diffuser.

8. The device of claim 3, further comprising:
a proximity sensor having a second FOV that includes at least a portion of the first FOV, the proximity sensor comprising one or more of:
an optical time-of-flight sensor,
a structured light sensor,
an optical parallax sensor,
a capacitive sensor, or
an ultrasonic sensor.

9. The device of claim 3, further comprising:
a sensor window arranged between an external environment and the camera assembly, the first polarized infrared light module, and the second polarized infrared light module, wherein the sensor window is transmissive to infrared light.

10. The device of claim 3, further comprising:
a third polarized infrared light module to illuminate at least a portion of the first FOV, the third polarized infrared light module comprising:
a third infrared light source,
a fourth polarizer with the second polarization, and
a fourth polarized infrared light module to illuminate at least a portion of the first FOV, the fourth polarized infrared light module comprising:
a fourth infrared light source, and
a fifth polarizer with the first polarization; and
wherein:
the first polarized infrared light module is arranged on a first side of an aperture of the camera assembly;
the third polarized infrared light module is arranged on a second side of the aperture of the camera assembly that is opposite the first side;
the second polarized infrared light module is arranged on a third side of the aperture of the camera assembly that is between the first and the third polarized infrared light modules; and
the fourth polarized infrared light module is arranged on a fourth side of the aperture of the camera assembly that is opposite the third side.

11. The device of claim 3, further comprising:
a visible light source; and
a first structure comprising an optically transmissive material, wherein at least a portion of the first structure comprises a light pipe that transfers visible light from the visible light source to an exterior surface of the first structure.

12. The device of claim 3, further comprising:
a plurality of visible light sources arranged along a perimeter that encompasses the camera assembly, the first polarized infrared light module, and the second polarized infrared light module.

13. The device of claim 3, further comprising:
one or more antitamper features; and
a card reader comprising one or more of:
a plurality of electrical contacts to provide electrical connections to an inserted card, or
a near field communication (NFC) communication interface.

14. The device of claim 3, further comprising:
a memory, storing first computer-executable instructions; and
a hardware processor to execute the first computer-executable instructions to:
operate the first infrared light source;
operate the second infrared light source; and
operate the image sensor.

15. A device comprising:
a camera assembly comprising:
an image sensor that is sensitive to infrared light, wherein the image sensor acquires images from within a first field of view (FOV), and
a first polarizer in an optical path of the image sensor;
a first polarized infrared light module to illuminate at least a portion of the first FOV, the first polarized infrared light module comprising:
a first infrared light source, and
a second polarizer;
a proximity sensor having a second FOV that includes at least a portion of the first FOV; and
a controller to:
responsive to data from the proximity sensor, operate the image sensor and the first infrared light source.

16. The device of claim 15, wherein the first polarizer is responsive to an input from the controller to selectively filter light, the first polarizer comprising one or more of:
a mechanically switchable polarizer comprising:
one or more actuators to move one or more polarizers, wherein the one or more polarizers include a first polarizing element that passes light with a first polarization and a second polarizing element that passes light with a second polarization;
a liquid crystal; or
a photoelastic modulator.

17. The device of claim 15, the first polarized infrared light module further comprising:
a first diffuser; and
a first barrier that is opaque to infrared light, wherein the first barrier is between the first infrared light source and the camera assembly.

18. The device of claim 15, the proximity sensor comprising one or more of:
an optical time-of-flight sensor,
a structured light sensor,
an optical parallax sensor,
a capacitive sensor, or
an ultrasonic sensor.

19. The device of claim 15, further comprising:
a sensor window arranged between an external environment and the camera assembly and the first polarized infrared light module, wherein the sensor window is transmissive to infrared light.

20. The device of claim 15, further comprising:
a plurality of visible light sources arranged along a perimeter that encompasses the camera assembly and the first polarized infrared light module.
